(19) United States
(12) Patent Application Publication
(10) Pub. No.: US 2008/0031165 A1
(43) Pub. Date: Feb. 7, 2008

(54) RS-232 data through a half duplex differential link

(76) Inventors: Fenghua Shen, Somerset, NJ (US); Huimin Cao, Belle Mead, NJ (US)

Correspondence Address: GIBBONS P.C., ONE GATEWAY CENTER, NEWARK, NJ, 07102, US

(21) Appl. No.: 11/499,942

(22) Filed: Aug. 7, 2006

(51) Int. Cl. H04B 3/36

(52) U.S. Cl. 370/293; 370/389

(57) ABSTRACT

RS-232 data flow over a half duplex differential link between a KVM switch and a SCIM, which is attached to a RS-232 serial communication port of a target device. The half duplex differential link is a data communication link of two wires that carry one pair of half duplex differential signals. In a communication direction from the SCIM to the KVM switch, the SCIM encodes and transmits full RS-232 signals over the half duplex differential link to the KVM switch, which in turn decodes and restores the RS-232 signals to present same in a desired format. Likewise, in a communication direction from the KVM switch to the SCIM, the KVM switch encodes and transmits the RS-232 signals to the SCIM, which in turn decodes and outputs RS-232 signals to the target device.

### FIELD OF THE INVENTION:

The present invention relates to transmitting and receiving RS-232 data. More specifically, the invention relates to transmitting and receiving RS-232 data through a half duplex differential link situated between a keyboard, video, and mouse (KVM) switch and a serial computer interface module (SCIM) connected to a serial port of a target device.

### BACKGROUND OF THE INVENTION

Keyboard, video and mouse (KVM) products provide remote access for control of keyboard, video and mouse. The majority of KVM products including Raritan Computer, Inc.'s KVM products transmit data over commonly used network standard unshielded twisted pair (UTP) Cat5 (Category 5) or Cat5e (extended Category 5) or Cat6 (Category 6) cable. UTP (Cat5/5e/6) cable has four twisted wire pairs. Each twisted pair of wires delivers one pair of differential signals. Three of the four twisted wire pairs are used for transmitting three pairs of differential video signals and the fourth pair is used for half duplex, differential signaling communication for keyboard/mouse and control data. A KVM computer interface module (CIM) connects to the KVM ports of an individual server and converts the video signals to differential signals for transmission over UTP (Cat5/5e/6) cable. KVM CIMs also deliver keyboard/mouse and control data to provide keep-alive keyboard/mouse emulation. An example of a KVM CIM can be found at U.S. patent publication No. 2005/0198245.

Current serial console control products provide remote serial port access including, for example Raritian Computers Inc.'s Dominion SX and ConsoleSwitch, which transmit data over UTP cable, but use a different signal definition from the KVM products. For serial communication, standard RS-232 voltage level signals are used, not differential signals.

For these current serial console control products, no CIM is required for the serial port of server/serial device, though conventionally, a nulling serial adaptor may be required. Such an adaptor has wires inside that directly connect DB9/DB25 pins to RJ45 pins. Signals are kept at the RS-232 level, which has a transmission distance of less than 50 feet.

While RS-232 is the most commonly used serial-data standard for PC and telecommunication applications, RS-485 and RS-422 are among the successful standards for industrial applications. Although these standards are not directly compatible, for purposes of control and instrumentation there are RS-232 to RS-485 converters on the market that convert RS-232 signals to RS-485 or RS-422 signals. Note that a RS-232 to full duplex RS-485 converter is quite different from a RS-232 to RS-485 half duplex converter because full duplex RS-485 communication uses two differential pairs (four signals). The RS-232 to full duplex RS-485 converter converts RS-232 TX and RX signals, respectively, to a differential signaling pair. RS-232 flow control signals are neither supported nor controlled by the data terminal end. Instead, they are supported or controlled by the RS-232 to full duplex RS-485 converter. In a RS-232 to half duplex RS-485 converter, the direction control for half duplex RS-485 is achieved by software or by a hardware detection circuit based on voltage, current or timing. Half duplex RS-485 signals can only be transmitted or received one at a time, i.e., not simultaneously. Thus, the converter needs to manage the Data Terminal Equipment (DTE) to not transmit and receive signals at the same time. None of the existing RS-232 to RS-485 or RS-422 converters can support flow control without interfering with communication between two DTEs at the same time.

Some KVM product vendors employ a VT-100 emulator to convert serial RS-232 data to VT-100 video. These kinds of emulators transmit video instead of real RS-232 data.

KVM products, such as those sold by Raritan, use a pair of half duplex, differential signals for keyboard, mouse and control data (this signal can be half duplex RS-485 or some other similar half duplex, differential signaling). Compared with RS-232 data transmission, this kind of half duplex differential link can transmit at much higher speed and for much longer distance since its differential nature helps cancel out noise.

It would be desirable to allow a customer to control a remote serial port as a true serial port without the need to use dedicated RS-232 serial ports and without the need for a direct RS-232 connection to a KVM port that requires multiplexing RS-232 signals with existing differential signals on the KVM switch. Dedicated RS-232 serial ports would have no flexibility and RS-232 signals cannot be transmitted over 50 feet. A direct RS-232 connection to a target port of a KVM switch and multiplexing RS-232 signals with existing differential signals increase cost significantly by requiring the addition of a protection circuit because RS-232 signals have much higher voltage than current differential signals in the target port. Again, no reliable transmission over 50 feet would be possible when the target port of a KVM switch is directly connected to a RS-232 serial target.

### BRIEF SUMMARY OF THE INVENTION

In accordance with one aspect of the invention, RS-232 data is transmitted and received through a half duplex differential link situated between a keyboard, video, and mouse (KVM) switch and a serial computer interface module (SCIM) connected to a serial port of a target device. The half duplex differential link may contain a pair of differential signals, the pair of differential signals carrying converted serial format frames that contain frame overhead and sampled RS-232 data with control data. KVM products are provided serial control via a SCIM. The SCIM may use the same signal definition in CAT5 cable as a specified KVM product except that the differential video signals are not used in the SCIM. In this way, KVM products can also control the serial port of a server/serial device.

In one aspect of the invention, target ports of a KVM switch can connect either to a SCIM or KVM computer interface module (KVM CIM). The SCIM is a computer interface module in accordance with the invention that uses the same data communication signals sent and received between a KVM switch and a conventional KVM CIM, but the SCIM connects to the serial port instead of the KVM ports of a target device. The target device could be for example, an individual server, a personal computer (PC), or any kind of a device with a RS-232 port. The data communication link of a KVM switch is a pair of half duplex differential signals. In this way, one can utilize a single, universal interface for the KVM products to access a remote KVM port or RS-232 port depending on the type of CIM, KVM CIM or SCIM, plugged into the target port of the KVM switch.

In another aspect of the invention, the SCIM samples all RS-232 input signals from a target device at a much higher speed than the maximum speed supported by the KVM products, then packetizes the sampled data with control data into a frame that is sent out in serial format. The serialized formatted signals are converted into a pair of differential signals and then transmitted over the data communication link of the KVM switch during the SCIM transmit time slot. The KVM switch receives this frame, then takes out and restores the original RS-232 signals.

In the opposite direction, a circuit inside of the KVM switch performs the sampling and encoding of the RS-232 output signals that a customer intends to send to the target device. During the SCIM receive time slot, the SCIM receives these frames and restores the RS-232 signals and sends them to the target device.

### BRIEF DESCRIPTION OF THE DRAWINGS

In the drawings:

FIG. 1 is a functional diagram of a SCIM in accordance with the invention.

FIG. 2 is a functional diagram of a KVM switch in accordance with the invention showing only blocks related to the invention.

FIG. 3 is a schematic representation of a system architecture in accordance with the invention, showing that target ports of a KVM switch can connect to either the SCIM of FIG. 1 or a KVM CIM.

### DETAILED DESCRIPTION OF THE INVENTION

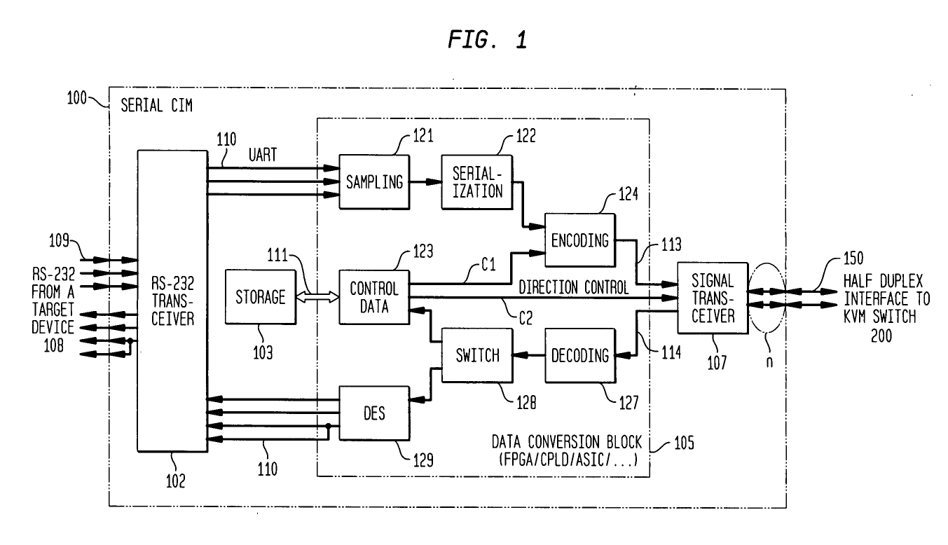

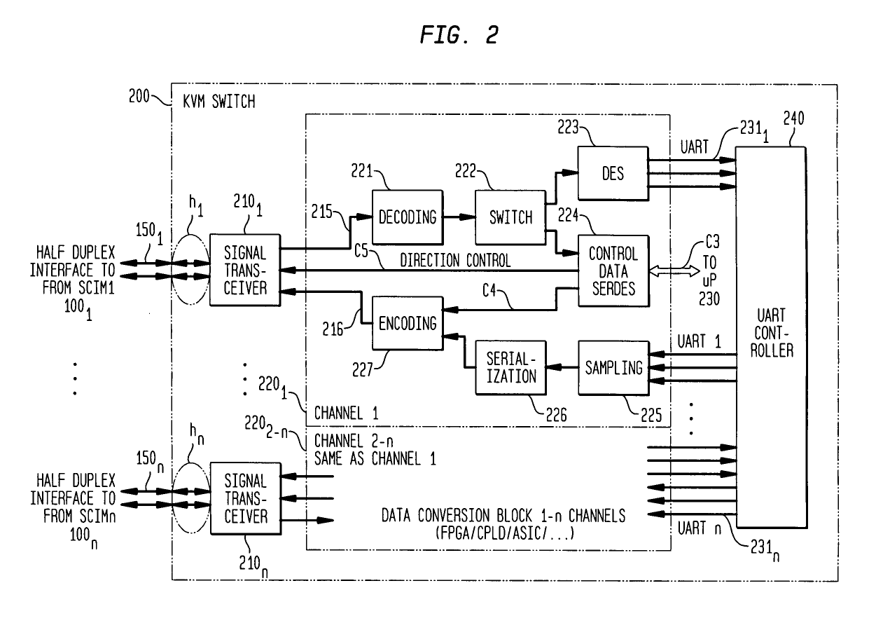

FIGS. 1 and 2 are block diagrams showing an asynchronous serial data standard RS-232 port remote access in KVM systems. In both figures, a half duplex interface is identified that constitutes a half duplex differential link in which is to be contained RS-232 data flow signals in accordance with the invention. The half duplex differential link contains a pair of differential signals in accordance with the invention. The pair of differential signals carries a converted serial format frames that contain frame overhead and sampled RS-232 data with control data. Frame overhead has the conventional meaning of bits in the form of binary digits that are added at regular intervals to a digital signal at the beginning or end of a digital link and used to provide network functions such as framing, operation, administration and maintenance.

As shown in FIG. 1, a serial computer interface (SCIM) 100 in accordance with the invention includes a RS-232 transceiver 102, a storage block 103, a data conversion block 105 and a signal transceiver 107. A target device 108, via a cable communication link such as a RS-232 cable 109, transmits/receives RS-232 signals to/from a SCIM 100. The RS-232 transceiver 102 in the SCIM 100 converts signal voltage levels between the RS-232 standard level and transistor-transistor logic/complementary metal oxide semiconductor (TTL/CMOS) logic level. Universal Asynchronous Receiver and Transmitter (UART) signals 110 are logic level RS-232 signals. The storage block 103 is a non-volatile memory, such as for example, read-only memory (ROM), erasable programmable read only memory (EPROM), electrically erasable programmable read only memory (EEPROM), Flash), which through a simple serial link 111 connects to the data conversion block 105. The serial link 111 may be UART, I2C (inter-integrated circuit bus), or SPI (Serial Peripheral Interface). The target device name and hardware identification information are saved in this storage block 103 and the content of the storage block 103 can be read or modified by the KVM switch 200.

The data conversion block 105 is the major functional unit in the SCIM 100 and performs the conversion between full logic RS-232 signals 110 and two single end signals 113 and 114. The data conversion comprises two relatively independent processes, packetizing and depacketizing. As the data flows from the RS-232 transceiver 102 to KVM switch 200, sampling circuit 121 first samples all UART input signals 110 at a much higher speed than the maximum supported UART speed and then converts them to serial data at the serialization block 122. There is also control data that needs to be transmitted between the SCIM 100 and the KVM switch 200. At the request of the KVM switch 200, the control data block 123 acquires the SCIM identification and/or other control data from the storage block 103 then sends it to an encoding block 124. The encoding block 124 assembles serialized UART data from serialization block 122 and control data C1 together into a format frame and then sends it out to the KVM switch 200. The control data block 123 also sends control data C2 to the signal transceiver 107 for controlling the direction of data flow between the SCIM 100 AND KVM switch 200.

As the data flows from KVM switch 200 to the RS-232 transceiver 102, decoding block 127, switch block 128 and deserialization (DES) block 129 are used to transfer the single end signal 114 into logic level RS-232 signals 110. The functions of the data conversion block 105 may be implemented in a Field Programmable Gate Array (FGPA), Complex Programmable Logic Devices (CPLD), Application Specific Integrated Circuit (ASIC) or any customized integrated circuit (IC).

The function of the signal transceiver block 107 is to convert signaling between two single end signals 113 and 114 and one half duplex differential pair h. The differential signals h are transmitted to KVM switch 200 via a half duplex differential link 150. The preferred signal transceiver 107 could be, but is not limited to, an RS-485 transceiver or low voltage differential signaling (LVDS) transceiver. RS-232, RS-485 and LVDS transceivers are commonly used ICs that are manufactured by numerous vendors (e.g. TI®, Intersil®, Maxim®, and Analog Devices®).

FIG. 2 shows functional blocks related to the SCIM inside of the KVM switch 200. KVM switch 200 includes a plurality of signal transceivers 210₁-210ₙ and data conversion blocks 220₁-220ₙ. The signal transceivers 210₁-210ₙ and data conversion blocks 220₁-220ₙ have the same functions as those shown in FIG. 1. For instance, transceiver block 210₁ converts signaling between two single end signals 215 and 216 and one half duplex differential pair h₁. The differential signals h₁ and hₙ are transmitted to SCIMs 100₁-100ₙ via half duplex differential links 150₁-150ₙ. The data conversion process in the KVM switch 200, however, is reversed compared with the SCIM 100. When the KVM switch 200 receives signal h₁, for example, on the half duplex link 150₁, a decoding block 221 first finds out the header information from the incoming frame and takes out encoded UART and control data. Then a switch block 222 routes incoming data to the corresponding blocks 223 and 224 for processing. Decoded UART data is sent to a deserialization block (DES) 223 to be deserialized back into UART signals 231₁. The control data C3 is sent to a microprocessor (uP) 230 for further processing.

As the data flows from UART controller 240 to signal transceiver 210₁, for example, sampling circuit 225 samples all incoming UART input signals and then converts them to serial data at the serialization block 226. There is also control data that needs to be transmitted between the SCIM 100 and the KVM switch 200. The encoding block 227 assembles serialized UART data from serialization block 226 and control data C4 together and then sends it out to signal transceiver 210₁. The control data Serdes block 224 also sends control data C5 to the signal transceiver 210₁ for controlling the direction of data flow between the SCIM 100₁ and KVM switch 200. Serdes refers to serialization and deserialization.

The signals between the data conversion blocks 220₁-220ₙ and the UART 240 are logic level RS-232 signals 231₁-231ₙ (the UART signals). The UART signals 231₁-231ₙ to the data conversion blocks 220₁-220ₙ at the KVM switch side are the same as the UART signals 110 at the SCIM side. Therefore, the SCIM is completely transparent to the two digital terminal equipment (DTEs). The customer can control any of the RS-232 signals. Both hardware flow control and software flow control are supported in this solution.

Certain KVM devices use a half duplex link for data communication and as such can only transmit or receive signals one at a time, i.e., not simultaneously. The signaling direction is controlled by the control data block 123 at the SCIM side and the control data Serdes block 224 at the KVM switch side. The SCIM provides a unique solution of transmitting RS-232 signals over half duplex differential links 150₁-150ₙ in KVM systems.

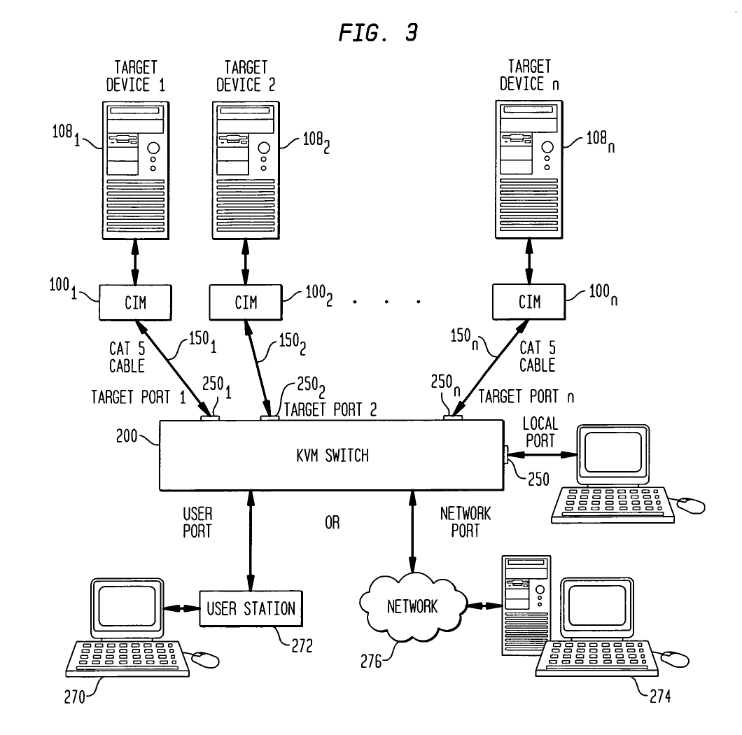

FIG. 3 shows a KVM remote access system in accordance with the invention. Each of CIMs 100₁-100ₙ is connected to a KVM port or serial port of one of the target devices 108₁-108ₙ, respectively. The CIM identified in FIG. 3 is either a KVM CIM or SCIM. This is because the target ports 250₁-250ₙ of KVM switch 200 may connect to either an SCIM or a KVM CIM.

The target device 108₁-108ₙ, may be an individual server, a PC or any kind of a device with a RS-232 port. Between CIMs 100₁-100ₙ and target ports 250₁-250ₙ of KVM switch 200 are half duplex differential links 150₁-150ₙ, which are preferably CAT5 cables. In the communication direction from the CIMs 100₁-100ₙ to the KVM switch 200, CIMs 100₁-100ₙ encode and transmit full RS-232 signals over the half duplex differential links 150₁-150ₙ to KVM switch 200. Then KVM switch 200 decodes and restores RS-232 signals. The KVM switch 200 presents RS-232 data to the local port 260 of KVM switch 200 or even further to a customer's PC 270 through a user station 272. In addition, KVM switch 200 may present RS-232 data to a customer's PC 274 through Ethernet Network 276 in some format that the customer desires.

Conversely, in the communication direction from KVM switch 200 to CIMs 100₁-100ₙ, KVM switch 200 encodes and transmits RS-232 signals to CIMs 100₁-100ₙ over the half duplex differential links 150₁-150ₙ. Then CIMs 100₁-100ₙ decode and output RS-232 signals to the target devices 108₁-108ₙ. In this way, a customer's PC such as 270 or 274 can fully access a RS-232 port of any of target devices 108₁-108ₙ.

Utilizing an architecture that is configured to transmit RS-232 data over the same half duplex differential link as a KVM CIM provides many benefits. For example, the invention results in a true serial connection, and not a VT-100 emulation. Therefore the RS-232 port of a target device is not limited to a text-based terminal. A KVM switch can get the same data that the target device sends out including text, special keyboard and customer specific commands. In essence, whatever one can do with and to a local RS-232 port, the same can be done with and to a remote RS-232 port through the KVM switch. In addition, the transmission data is not limited to 50 feet.

Moreover, use of the SCIM results in no interference between two DTEs. The SCIM will not change any RS-232 control signals to manage the direction of the half duplex link. The SCIM is transparent for a KVM switch and target device.

Additionally, full hardware flow control and software flow control are supported. The invention provides target device, name labeling feature and allows for flexible target port configuration in KVM products in that either KVM port access or RS-232 serial port access can be achieved depending on the CIM type plugged in.

The signal definition of RS-232 (DB9, or DB25, etc.) includes:

TX—Transmit Data

DTR—Data Terminal Ready

RTS—Request to Send

RX—Receive Data

DSR—Data Set Ready

CTS—Clear To Send

CD—Carried Detect, wired together with DSR

RI—Not used

GND—Ground

### UART has the same signals except that UART is TTL/CMOS level.

The signal definition of half duplex differential link (RJ45) includes:

D+—Positive signal

D−—Negative signal

Other 6 pins—Reserved for video signals

Therefore, the invention pertains to an architecture for a KVM switch that presents RS-232 data to the local port of a KVM switch or even further to customer's PC through a user station or Ethernet Network in some format the customer desires. In this way, the customer can fully access the RS-232 port of a target device. The serial interface of these two DTEs, KVM switch and target device, are likewise connected directly together but for a longer distance. Customers can remotely access the serial port of a target device as a true serial port.

The invention pertains to a system and method for transmitting RS-232 signals over a half duplex differential link. The system comprises a SCIM and a KVM switch. The SCIM is attached to the RS-232 serial communication port of a target device. The data communication link between the KVM switch and the SCIM has two wires, which carries one pair of half duplex differential signals.

The same architecture could be applied to a KVM switch to remotely access any port composed of a plurality of signals which has a much lower speed than the data communication link of the KVM switch. The port of a target device could be, but not limited to, industry standard interfaces (such as RS-232, parallel), and customer proprietary interfaces (such as interface of sensor, apparatus control port).

While the foregoing description and drawings represent the preferred embodiments of the present invention, it will be understood that various changes and modifications may be made without departing from the spirit and scope of the present invention.

What is claimed is:

1. RS-232 data flow through a half duplex differential link between a keyboard, video and mouse switch and a serial computer interface module, comprising:
a half duplex differential link containing a pair of differential signals, the pair of differential signals carrying a conversion of frames in serial format that contain frame overhead and sampled RS-232 data with control data.

2. The RS-232 data flow of claim 1, wherein the frames are configured to enable extraction and restoration of RS-232 signals from the RS-232 data.

3. The RS-232 data flow of claim 1, further comprising:
a signal transceiver block configured to convert signaling as between two single end signals and the pair of differential signals,
a data conversion block in signal communication with the signal transceiver block and configured to perform packetizing and depacketizing functions independent of each other; the data conversion block including:
a signal sampling block arranged to sample input signals;
a control block configured to acquire the control data and to set a direction of the signaling;
a serializing block configured to serialize the sampled input signals to provide serialized data;
an encoding block configured to assemble and encode the serialized data and the acquired control data together into the frames to send out,
a decoding block configured to decode further encoded, serialized data and further control data within a further frame and to extract the serialized data from the further frame and to extract the further control data from the further frame;
a deserialization block configured to deserialize the extracted serialized data; and
a switch block configured to route the extracted, serialized data to the deserialization block and to route the extracted further control data to a microprocessor.

4. The RS-232 data flow of claim 3, wherein the signal transceiver block and the data conversion block are within a keyboard, video and mouse (KVM) switch, the KVM switch being in communication with a half duplex interface via the signal transceiver block.

5. The RS-232 data flow of claim 3, wherein the signal transceiver block and the data conversion block are part of a serial computer interface module (SCIM), the SCIM being in communication with a half duplex interface via the signal transceiver block.

6. The RS-232 data flow of claim 5, further comprising a storage block containing non-volatile memory in connection with the data conversion block via a serial link, the control block configured to acquire the control data from the storage block.

7. The RS-232 data flow of claim 5, further comprising RS-232 transceiver configured to convert RS-232 voltage level signals to logical level UART (Universal Asynchronous Receiver and Transmitter) signals.

8. The RS-232 data flow of claim 5, wherein the RS-232 voltage level signals include transmit data (TX), data terminal ready (DTR), request to send (RTS), receive data (RX), data set ready (DSR), clear to send (CTS), and carried detect (CD).

9. The RS-232 data flow of claim 4, wherein a half duplex differential interface is in communication with the signal transceiver block and the differential link has a positive signal and a negative signal.

10. The RS-232 data flow of claim 5, wherein each of the blocks are free of any direct RS-232 voltage level signal connecting with a KVM switch.

11. The RS-232 data flow of claim 4, wherein each of the blocks is free of any protection circuit configured to provide circuit protection from RS-232 level voltage.

12. The RS-232 data flow of claim 5, wherein the signal transceiver block is configured to transmit the half duplex differential pair to span a distance greater than a distance of 50 feet.

13. The RS-232 data flow of claim 4, wherein the signal transceiver block is configured to transmit the half duplex differential pair to span a distance greater than a distance of 50 feet.

14. A RS-232 data flow of claim 5, further comprising a port of a target device arranged to receive transmission of the RS-232 signals over the half duplex differential link, the port having standard RS-232 interfaces and further interfaces that accommodate signals provided they are at least eight times lower in speed than those that may be accommodated by the differential link.

15. A method of RS-232 data flow through a half duplex differential link between a keyboard, video and mouse switch and a serial computer interface module, comprising containing a pair of differential signals within a half duplex differential link that are carrying a conversion of frames in serial format, which contain frame overhead and sampled RS-232 data with control data.

16. A method of claim 15, further comprising configuring the frames to enable extraction and restoration of the RS-232 signals.

17. A method of claim 15, comprising
converting two single end signals into the pair of differential signals using a signal transceiver block,
performing packetizing and depacketizing functions independent of each other with a data conversion block in signal communication with the signal transceiver block that includes:
sampling input signals with a signal sampling block;
serializing the sampled input signals into serialize data;
acquiring control data and setting a direction of signaling with a control block;
assembling and encoding the serialized data and the acquired control data together into the frames to send out, the assembling and encoding being carried out with an encoding block,
decoding further encoded, serialized data and further control data within a further frame and extracting the serialized data from the further frame and extracting the further control data from the further frame all of which being carried out with a decoding block;
deserializing the extracted serialized data with a deserialization block; and
routing the extracted, serialized data to the deserialization block and routing the extracted further control data to a microprocessor by using a switch block.

18. The method of claim 15, further comprising arranging the signal transceiver block and the data conversion block within a keyboard, video and mouse (KVM) switch, the KVM switch being in communication with a half duplex interface via the signal transceiver block.

19. The method of claim 15, further comprising arranging the signal transceiver block and the data conversion block as part of a serial computer interface module (SCIM), the SCIM being in communication with a half duplex interface via the signal transceiver block.

20. The method of claim 19, further comprising containing non-volatile memory within a storage block in connection with the data conversion block via a serial link, acquiring the control data from the storage block by using the control block.

21. The method of claim 19, further comprising converting RS-232 voltage level signals to logical level UART (Universal Asynchronous Receiver and Transmitter) signals by using a RS-232 transceiver.

22. The method of claim 19, wherein each of the blocks are free of any direct RS-232 voltage level signal connecting with a KVM switch.

23. The method of claim 18, wherein each of the blocks is free of any protection circuit configured to provide circuit protection from RS-232 level voltage.

24. The method of claim 19, further comprising transmitting the half duplex differential pair by using the signal transceiver to span a distance greater than a distance of 50 feet.

25. The method of claim 18, further comprising transmitting the half duplex differential pair by using the signal transceiver to span a distance greater than a distance of 50 feet.

26. A method of claim 19, further comprising receiving transmission of the RS-232 signals over the half duplex differential link with a port of a target device, the port having standard RS-232 interfaces and further interfaces that accommodate signals provided they are at least eight times lower in speed than those that may be accommodated by the differential link.

27. A half duplex differential link containing a RS-232 signal that is in a form of encoded and serialized data.

28. A serial computer interface module for transceiving RS-232 signals over a half duplex differential link, comprising:
a data conversion block for converting outgoing RS-232 signals to serially formatted frames with control data in a first direction;
the data conversion block deconverting incoming serially formatted frames with control data to RS-232 signals in a second direction; and
a signal transceiver block for controlling sending and receiving of the outgoing serially formatted frames and incoming serially formatted frames over the half duplex differential link.

29. The serial computer interface module of claim 28, wherein the data conversion block further comprises:
a sampling block for sampling the RS-232 signals;
a serialization block to serialize sampled RS-232 signals; and
a control block for acquiring control data and controlling the direction of the communication with the signal transceiver block; and
an encoding block for assembling serialized data with the control data into the outgoing serially formatted frames.

30. The serial computer interface module of claim 29, wherein the data conversion block further comprises:
a decoding block for extracting control data and serialized data from the incoming serially formatted data;
a deserialization block for extracting data from the serialized data; and
the control block receiving the control data.

31. The serial computer interface module of claim 29, further comprising a storage block connected to the control block, the storage block storing control data.

32. The serial computer interface module of claim 28, further comprising a transceiver for converting outgoing RS-232 signals to predetermined logic level signals in a first direction and for converting predetermined logic level signals to RS-232 signals for incoming serially formatted frames in a second direction.

33. A keyboard, video, mouse (KVM) switch for transceiving RS-232 signals over a half duplex differential link, comprising:
at least one data conversion block for converting outgoing RS-232 signals to serially formatted frames with control data in a first direction;
the at least one data conversion block deconverting incoming serially formatted frames with control data to RS-232 signals in a second direction; and
a signal transceiver block for controlling sending and receiving of the outgoing serially formatted frames and incoming serially formatted frames over the half duplex differential link.

34. The KVM switch of claim 33, wherein the data conversion block further comprises:
a sampling block for sampling the RS-232 signals;
a serialization block to serialize sampled RS-232 signals; and
a control block for acquiring control data and controlling the direction of the communication with the signal transceiver block; and
an encoding block for assembling serialized data with the control data into the outgoing serially formatted frames.

35. The KVM switch of claim 34, wherein the data conversion block further comprises:
a decoding block for extracting control data and serialized data from the incoming serially formatted data;
a deserialization block for extracting data from the serialized data; and
the control block receiving the control data.

36. The KVM switch of claim 34, further comprising a microprocessor connected to the control block.

37. The KVM switch of claim 33, further comprising at least one transceiver for converting outgoing RS-232 signals to predetermined logic level signals in a first direction and for converting predetermined logic level signals to RS-232 signals for incoming serially formatted frames in a second direction.

38. A system for transceiving RS-232 signals over a half duplex differential link, comprising:
at least one serial computer interface module (SCIM);
a keyboard, video, mouse (KVM) switch connected to the at least one SCIM over the half duplex differential link;
wherein each of the at least one SCIM and the KVM switch further comprises:
a data conversion block for converting outgoing RS-232 signals to serially formatted frames with control data in a first direction;
the data conversion block deconverting incoming serially formatted frames with control data to RS-232 signals in a second direction; and
a signal transceiver block for controlling sending and receiving of the outgoing serially formatted frames and incoming serially formatted frames over the half duplex differential link.

39. The system of claim 38, wherein the data conversion block further comprises:
a sampling block for sampling the RS-232 signals;
a serialization block to serialize sampled RS-232 signals; and
a control block for acquiring control data and controlling the direction of the communication with the signal transceiver block; and
an encoding block for assembling serialized data with the control data into the outgoing serially formatted frames.

40. The system of claim 39, wherein the data conversion block further comprises:
a decoding block for extracting control data and serialized data from the incoming serially formatted data;
a deserialization block for extracting data from the serialized data; and
the control block receiving the control data.

41. A method for transceiving RS-232 signals over a half duplex differential link, comprising:
converting outgoing RS-232 signals to serially formatted frames with control data in a first direction;
deconverting incoming serially formatted frames with control data to RS-232 signals in a second direction; and
controlling sending and receiving of the outgoing serially formatted frames and incoming serially formatted frames over the half duplex differential link.

42. The method of claim 41, wherein the step of converting further includes the steps of:
sampling the RS-232 signals;
serializing sampled RS-232 signals; and
acquiring control data; and
assembling serialized data with the control data into the outgoing serially formatted frames.

43. The method of claim 42, wherein the step of deconverting further includes the steps of:
extracting control data and serialized data from the incoming serially formatted data;
extracting data from the serialized data; and
forwarding the control data to a control block.

44. The method of claim 41, wherein:
the step of converting further includes the step of converting outgoing RS-232 signals to predetermined logic level signals in a first direction; and
the step of deconverting further includes the step of converting predetermined logic level signals to RS-232 signals for incoming serially formatted frames in a second direction.
